(19) United States
(12) Patent Application Publication
(10) Pub. No.: US 2012/0122514 A1
(43) Pub. Date: May 17, 2012

(54) SELECTING NETWORK SERVICE PROVIDERS FOR MULTI-MODE MOBILE DEVICES

(75) Inventors: Steven D. Cheng, San Diego, CA (US); Tom Chin, San Diego, CA (US); Guangming Shi, San Diego, CA (US); Kuo-Chin Lee, San Diego, CA (US)

(73) Assignee: QUALCOMM Incorporated, San Diego, CA (US)

(21) Appl. No.: 13/352,240

(22) Filed: Jan. 17, 2012

Related U.S. Application Data
(63) Continuation-in-part of application No. 12/256,882, filed on Oct. 23, 2008.

(51) Int. Cl. H04W 48/18

(52) U.S. Cl. 455/524

(57) ABSTRACT

A method for facilitating dynamic service-based network selection and determination may be implemented by a communications device. A device may choose a network and/or network access provider (NAP) based on a type of service desired by a user. For the service, the system may determine which NAP provides the most desired service level for a particular network service provider (NSP). The desired service level may include such factors as power consumption, communication performance, past performance, cost, reward availability, etc. Thus, a user chooses a particular service and the system chooses the network that will provide the service at a desired level to the user.

### CROSS REFERENCE TO RELATED APPLICATIONS

This application is a continuation-in-part of U.S. patent application Ser. No. 12/256,882 filed Oct. 23, 2008, in the names of SHI et al., the disclosure of which is expressly incorporated herein by reference in its entirety.

### BACKGROUND

1. Field

The present disclosure relates generally to communication systems. More specifically, the present disclosure relates to methods and apparatus for facilitating dynamic service-based system selection and determination in wireless communication system.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in wireless technology. Preferably, these improvements should be applicable to any multi-access technology and the telecommunication standards that employ these technologies.

### SUMMARY

Offered is a method of wireless communication. The method includes selecting a type of service. The method also includes determining available network access providers, comprising cellular and non-cellular networks. The method further includes prioritizing available network access providers based at least in part on the selected type of service.

Offered is an apparatus for wireless communication. The apparatus includes means for selecting a type of service. The apparatus also includes means for determining available network access providers, comprising cellular and non-cellular networks. The apparatus further includes means for prioritizing available network access providers based at least in part on the selected type of service.

Offered is a computer program product. The computer program product includes a non-transitory computer-readable medium having non-transitory program code recorded thereon. The non-transitory program code includes program code to select a type of service. The non-transitory program code also includes program code to determine available network access providers, comprising cellular and non-cellular networks. The non-transitory program code further includes program code to prioritize available network access providers based at least in part on the selected type of service.

Offered is an apparatus for wireless communication. The apparatus includes a processor(s) and a memory coupled to the processor(s). The processor(s) is configured to select a type of service. The processor(s) is also configured to determine available network access providers, comprising cellular and non-cellular networks. The processor(s) is further configured to prioritize available network access providers based at least in part on the selected type of service.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a wireless communication system with multiple base stations and multiple mobile devices.

FIG. 2 illustrates a block diagram of a design of a base station and a mobile device.

FIG. 3 illustrates an example of a system that is configured for facilitating dynamic service-based system selection and determination.

FIG. 4 illustrates an example of a method for facilitating dynamic service-based system selection and determination.

FIG. 5 illustrates means-plus-function blocks corresponding to the method of FIG. 4.

FIG. 6 illustrates an example of a network service provider (NSP) record.

FIG. 7 illustrates an example of a network access provider (NAP) record.

FIG. 8 illustrates some examples of system selection options.

FIG. 8A illustrates NAP selection for a single mode mobile device according to one aspect of the present disclosure.

FIG. 8B illustrates NSP selection for a single mode mobile device according to one aspect of the present disclosure.

FIG. 8C illustrates NAP selection for a multiple mode mobile device according to one aspect of the present disclosure.

FIG. 8D illustrates NSP selection for a multiple mode mobile device according to one aspect of the present disclosure.

FIG. 8E is a block diagram illustrating a method for matching an NAP with an NSP according to one aspect of the present disclosure.

FIG. 8F is a block diagram illustrating components for matching an NAP with an NSP according to one aspect of the present disclosure.

FIG. 9 illustrates an example of a method for locating a serving system in accordance with the present disclosure.

FIG. 10 illustrates means-plus-function blocks corresponding to the method of FIG. 9.

FIG. 11 illustrates an example showing certain aspects of the structure of a frame in a WiMAX network.

FIG. 12 illustrates certain components that may be included within a mobile device that is configured for facilitating dynamic service-based system selection and determination in accordance with the present disclosure.

### DETAILED DESCRIPTION

A number of mobile communication devices are capable of communicating over more than one network type/wireless communication technology. Network types include cellular networks (such as 3GPP, 3GPP2, WiMAX, etc.) or non-cellular networks such as WLAN (wireless local area network), Peer-to-Peer networks, etc. Each network type is accessed through a network access point (NAP). Each NAP represents a communication front end from the perspective of a mobile device. The mobile device connects to a particular network access point (such as a cellular base station, WLAN (e.g., WiFi) access terminal, etc.) in order to access certain services or content available through the network (such as telephone communications, web browsing, private content services (such as YouTube, Netflix, Skype), etc.). The provider of the desired mobile service or content may be referred to as a network service provider (NSP). Each NSP represents a communication back end from the perspective of a mobile device.

In certain situations, one particular access point may be more well suited to access particular content than another. For example, a WiFi network at a place of business may not allow access to certain social media or content providers (such as Facebook, Netflix, etc.) In another example, certain wireless networks may be expensive for broadband content whereas others may offer free access to certain content. Cost may depend on whether a user of a mobile device has a subscription to a particular service. For example, a user may pay for 4G wireless service by the minute, but may be permitted limited free 3G access for certain services, such as YouTube. Or, a user may be entitled to a certain amount of free 4G service for broadband content but may be at the end of the free period of one network type (such as at the end of the month having used the allotted 4G free minutes) and may desire to switch to another network type (e.g., 3G) rather than pay for extra time on the original (4G) network. In another example, a mobile device be able access to both a free cellular network and a free WLAN network but would see reduced power by accessing the WLAN network for streaming video.

In these situations, it may be desirable to select the network and the network access point based on the desired content. A user may indicate to a mobile device the desired content (for example, a digital copy of a newspaper) and the mobile device will determine the highest priority available network access point to obtain the desired content/service.

A level of priority for particular network access points (NAPs) based on the desired content may be based on a variety of factors including:
Monetary cost of the NAP to deliver the content
Availability of rewards for using the NAP
Type of service of the NAP
Performance of the mobile device based on the NAP (such as battery consumption, better reception, etc.)
Performance of the NAP (such as data rate, NAP reliability, etc.)

The mobile device may store information relating to how certain NAPs perform as related to certain content. (For example, how a specific NAP handles Skype calls.) That information may also include historical performance data for the particular NAPs.

As used herein, the term “mobile device” refers to an electronic device that may be used for voice and/or data communication over a wireless communication network. Examples of mobile devices include cellular phones, personal digital assistants (PDAs), handheld devices, wireless modems, laptop computers, personal computers, etc. A mobile device may alternatively be referred to as an access terminal, a mobile terminal, a mobile station, a subscriber station, a remote station, a user terminal, a terminal, a subscriber unit, user equipment, etc.

A wireless communication network may provide communication for a number of mobile devices, each of which may be serviced by a base station. A base station may alternatively be referred to as an access point, a Node B, or some other terminology.

A mobile device may communicate with one or more base stations via transmissions on the uplink and the downlink. The uplink (or reverse link) refers to the communication link from the mobile device to the base station, and the downlink (or forward link) refers to the communication link from the base station to the mobile device.

The resources of a wireless communication network (e.g., bandwidth and transmit power) may be shared among multiple mobile devices. A variety of multiple access techniques are known, including code division multiple access (CDMA), time division multiple access (TDMA), frequency division multiple access (FDMA), and orthogonal frequency division multiple access (OFDMA).

The techniques described herein may be used for various communication systems such as Code Division Multiple Access (CDMA) systems, Time Division Multiple Access (TDMA) systems, Frequency Division Multiple Access (FDMA) systems, Orthogonal FDMA (OFDMA) systems, Single-Carrier FDMA (SC-FDMA) systems, Spatial Division Multiple Access (SDMA) systems, multiple-input multiple-output (MIMO) systems, and so forth. The terms “system” and “network” may be used interchangeably herein.

A CDMA system may implement a radio technology such as Universal Terrestrial Radio Access (UTRA), cdma2000, etc. UTRA includes Wideband CDMA (W-CDMA) and other CDMA variants. The cdma2000 technology covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.20, IEEE 802.16 (WiMAX), 802.11 (WiFi), Flash-OFDM®, etc.

UTRA and E-UTRA are part of UMTS. 3GPP Long Term Evolution (LTE) is a release of UMTS that uses E-UTRA. UTRA, E-UTRA, UMTS, LTE and GSM are described in documents from an organization named the “3rd Generation Partnership Project” (3GPP). UMB and cdma2000 are described in documents from an organization named the “3rd Generation Partnership Project 2” (3GPP2).

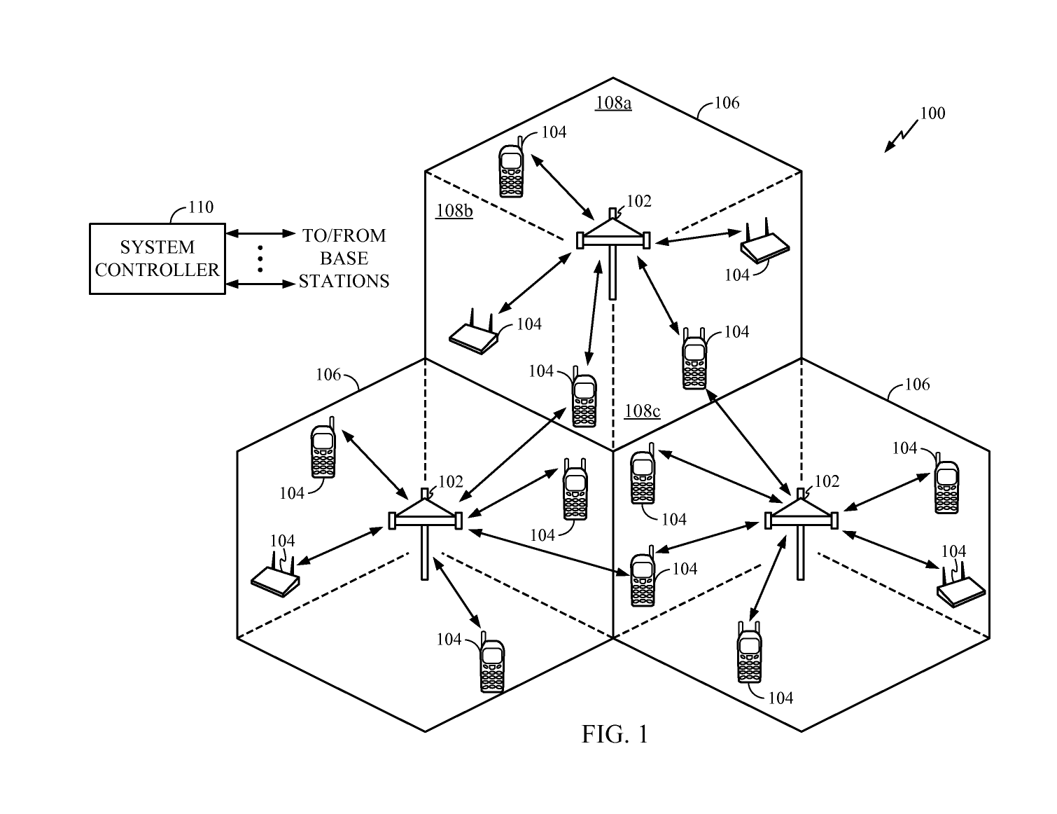

FIG. 1 shows a wireless communication system 100 with multiple base stations 102 and multiple mobile devices 104. A base station 102 is a station that communicates with the mobile devices 104. A base station 102 may also be called, and may contain some or all of the functionality of, an access point, a Node B, an evolved Node B, etc. Each base station 102 provides communication coverage for a particular geographic area 106. The term “cell” can refer to a base station 102 and/or its coverage area 106 depending on the context in which the term is used. To improve system capacity, a base station coverage area 106 may be partitioned into multiple smaller areas, e.g., three smaller areas 108a, 108b, and 108c. Each smaller area 108a, 108b, 108c may be served by a respective base transceiver station (BTS). The term “sector” can refer to a BTS and/or its coverage area 108 depending on the context in which the term is used. For a sectorized cell, the BTSs for all sectors of that cell are typically co-located within the base station 102 for the cell.

Mobile devices 104 are typically dispersed throughout the system 100. A mobile device 104 may also be called, and may contain some or all of the functionality of, a terminal, an access terminal, a user equipment, a subscriber unit, a station, etc. A mobile device 104 may be a cellular phone, a personal digital assistant (PDA), a wireless device, a wireless modem, a handheld device, a laptop computer, etc. A mobile device 104 may communicate with zero, one, or multiple base stations 104 on the downlink (DL) and/or uplink (UL) at any given moment. The downlink (or forward link) refers to the communication link from the base stations 102 to the mobile devices 104, and the uplink (or reverse link) refers to the communication link from the mobile devices 104 to the base stations 102.

For a centralized architecture, a system controller 110 may couple to base stations 102 and provide coordination and control for these base stations 102. The system controller 110 may be a single network entity or a collection of network entities. For a distributed architecture, base stations 102 may communicate with one another as needed.

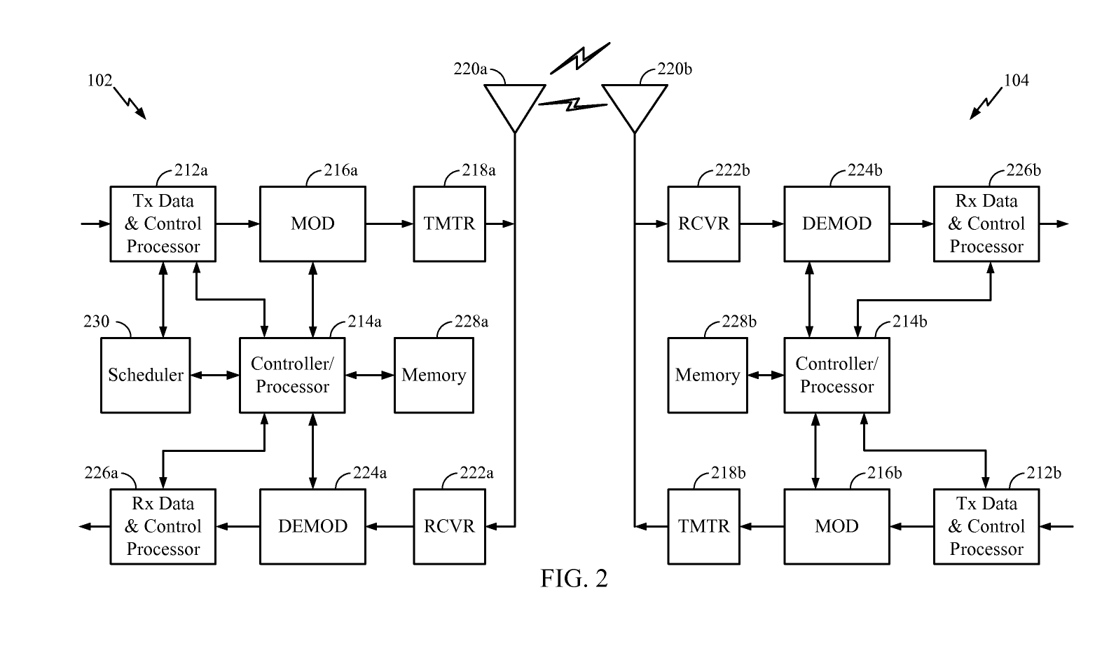

FIG. 2 shows a block diagram of a design of a base station 102 and a mobile device 104, which may be one of the base stations 102 and one of the mobile devices 104 in FIG. 1. At the base station 102, a transmit (TX) data and control processor 212a may receive traffic data from a data source (not shown) and/or control information from a controller/processor 214a. The processor 212a may process (e.g., format, encode, interleave, and symbol map) the traffic data and control information and provide modulation symbols. A modulator (MOD) 216a may process the modulation symbols (e.g., for OFDM) and provide output chips. A transmitter (TMTR) 218a may process (e.g., convert to analog, amplify, filter, and upconvert) the output chips and generate a downlink signal, which may be transmitted via an antenna 220a.

At the mobile device 104, an antenna 220b may receive the downlink signals from the base station 102 and other base stations 102 and may provide a received signal to a receiver (RCVR) 222b. The receiver 222b may condition (e.g., filter, amplify, downconvert, and digitize) the received signal and provide received samples. A demodulator (DEMOD) 224b may process the received samples (e.g., for OFDM) and provide demodulated symbols. A receive (RX) data and control processor 226b may process (e.g., symbol demap, deinterleave, and decode) the demodulated symbols to obtain decoded data and control information for the mobile device 104.

On the uplink, at the mobile device 104, data and control information to be sent by the mobile device 104 may be processed by a TX data and control processor 212b, modulated by a modulator 216b, conditioned by a transmitter 218b, and transmitted via an antenna 220b. At the base station 102, the uplink signals from the mobile device 104 and possibly other mobile devices 104 may be received by an antenna 220a, conditioned by a receiver 222a, demodulated by a demodulator 224a, and processed by an RX data and control processor 226a to recover the data and control information sent by the mobile device 104. In general, the processing for uplink transmission may be similar to or different from the processing for downlink transmission.

Controllers/processors 214a and 214b may direct the operation at the base station 102 and the mobile device 104, respectively. Memories 228a and 228b may store data and program codes for the base station 102 and the mobile device 104, respectively. A scheduler 230 may schedule mobile devices 104 for downlink and/or uplink transmission and may provide assignments of system resources.

The term “4G,” which is an abbreviation for fourth generation, is a term used to describe the next complete evolution in wireless communications. A 4G system may be able to provide a comprehensive Internet Protocol (IP) solution where voice, data and streamed multimedia can be given to users at higher data rates than previous generations. Examples of 4G systems include WiMAX and 3GPP Long Term Evolution (LTE).

The term “3G” refers to the third generation of mobile phone standards and technologies, whereas the term “2G” refers to the second generation of mobile phone standards and technologies. Examples of 3G systems include the Universal Mobile Telecommunications System (UMTS) and CDMA2000. Examples of 2G systems include the Global System for Mobile communications (GSM) and cdmaOne.

The present disclosure relates to mobile devices that are configured for operation in a 4G network. Such mobile devices may also be configured for operation in one or more 2G and/or 3G networks in addition to one or more 4G networks. Mobile devices that are configured in this manner may be referred to as “multi-mode” devices.

One significant issue for mobile devices is to quickly find a serving system that the user prefers to use. This issue may arise after power up, when the device needs a system re-selection after losing the current serving system, etc. Being able to quickly find a serving system that the user prefers to use enables the device to serve the user quickly and reduces the power consumption.

To the user, the issue is how to dynamically select service provider(s) and service(s) based on what the user wants, rather than having the choice of service provider(s)/service(s) fixed by the network operators. The following are some examples:

### EXAMPLE 1

User A uses service provider X for basic web and email service, and also likes to use service provider Y for IPTV programs.

### EXAMPLE 2

User B wants to change the basic data service for web and email from service provider N to service provider M because service provider M now offers a cheaper monthly fee with higher speed.

### EXAMPLE 3

A new service provider S is now available with a 3D interactive gaming service. User C gets notified and wants to sign up for the service.

The present disclosure proposes systems, methods and apparatus for providing these types of capabilities. More specifically, the present disclosure relates to dynamic service-based system selection and determination. The techniques disclosed herein may be utilized by multi-mode mobile devices, which may be configured for operation in one or more 2G and/or 3G networks in addition to one or more 4G networks.

In the present disclosure, the term Network Access Provider (NAP) refers to an entity that provides a physical link to a wireless communication network. The term Network Service Provider (NSP) refers to an entity that provides services (e.g., Internet Protocol television (IPTV), 3D gaming, World Wide Web access, email, instant messaging, Voice over IP (VoIP), etc.) via a wireless communication network. An NAP and an NSP can be the same entity or different entities.

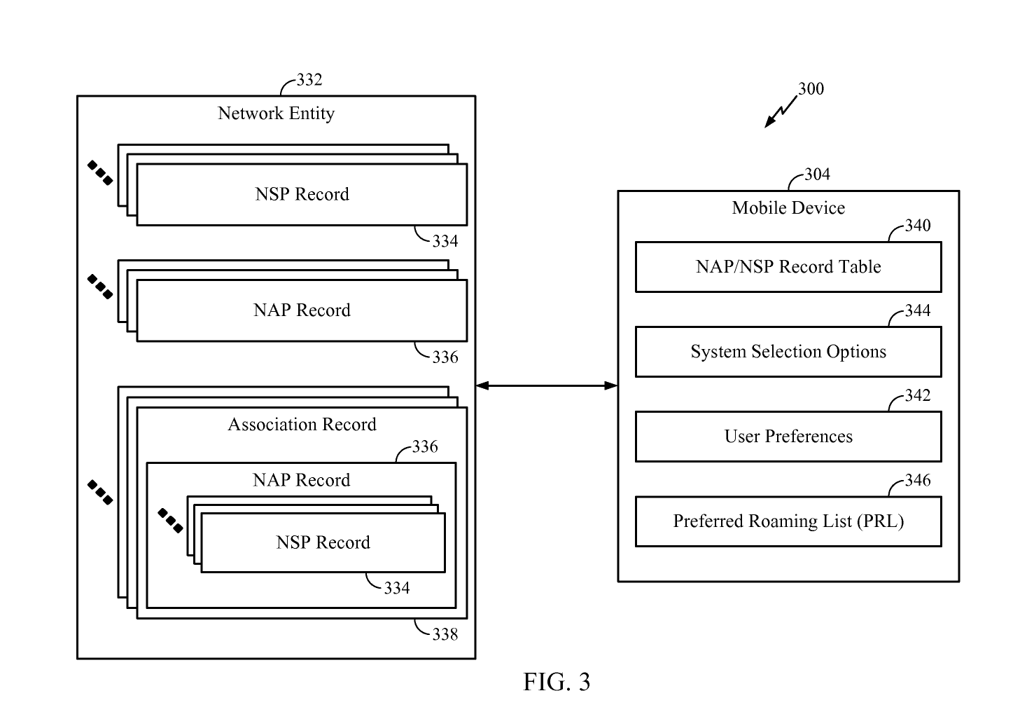

Reference is now made to FIG. 3. FIG. 3 illustrates an example of a system 300 that is configured for facilitating dynamic service-based system selection and determination. Such a system 300 may include multiple network entities 332 and multiple mobile devices 304. For simplicity, however, a single network entity 332 and a single mobile device 304 are shown in FIG. 3.

The network entity 332 and the mobile device 304 may be configured for operation in a high-speed wireless communication network, such as WiMAX or another type of 4G network. The mobile device 304 may be a multi-mode device, i.e., it may be configured for operation in various 2G and/or 3G networks in addition to one or more 4G networks.

The network entity 332 is shown with multiple Network Service Provider (NSP) records 334 and multiple Network Access Provider (NAP) records 336. Each NSP record 334 may include information about a particular NSP, and each NAP record 336 may include information about a particular NAP. Examples of the contents of the NSP records 334 and the NAP records 336 will be provided below.

One NAP can support multiple NSPs. Accordingly, the network entity 332 is also shown with multiple association records 338. Each association record 338 may indicate an association between a particular NAP record 336 and one or more NSP records 334. In this context, an association between an NAP record 336 and an NSP record 334 may indicate that the NSP to which the NAP record 336 refers is available via the NAP to which the NAP record 336 refers.

The network entity 332 may be configured to transmit one or more NAP records 336 and associated NSP records 334 to mobile devices 304. There are many ways that this may be accomplished. The NAP records 336 and associated NSP records 334 may be transmitted to a mobile device 304 via an over-the-air connection or via a local cabled connection. The NAP records 336 and the associated NSP records 334 may be broadcast to multiple mobile devices 304. In a WiMAX system, the NAP records 336 and the associated NSP records 334 may be included in a downlink MAP (DL-MAP) message that is transmitted to mobile devices 304.

The mobile device 304 may be configured to receive NAP records 336 and associated NSP records 334 from the network entity 332, and to decode the NAP records 336 and associated NSP records 334. The mobile device 304 may also be configured to create an NAP/NSP record table 340. The NAP/NSP record table 340 may be created based on the information that is contained within the NAP records 336 and the associated NSP records 334. For each available NAP, the NAP/NSP record table 340 may indicate the NSPs that are associated with the NAP, as well as information about the services that are provided by those NSPs.

The mobile device 304 may also be configured to determine user preferences 342 regarding various options 344 for system selection. This may involve presenting information to the user about the system selection options 344, and receiving user input regarding which system selection options 344 are preferred. The system selection options 344 may be determined based on information in the NAP/NSP record table 340. Examples of system selection options 344 will be provided below.

The mobile device 304 may also be configured to create a preferred roaming list (PRL) 346 based on the user preferences 342 that are determined. Information in the NAP records 336 (e.g., network parameters) may be used to create the PRL 346.

The PRL 346 may be used to perform network/channel scanning and to find serving systems. The PRL 346 may be used to quickly find a serving system after power up, when the device 304 needs a system re-selection after losing the current serving system, etc.

From time to time, the NAP records 336 and the NSP records 334 may be updated. When this occurs, the updated NAP records 336 and associated NSP records 334 may be transmitted to the mobile device 304. The mobile device 304 may be configured to dynamically update the data on the mobile device 304 based on the updated NAP records 336 and the associated NSP records 334. For example, when updated NAP records 336 and associated NSP records 334 are received, the NAP/NSP record table 340 may be updated, which may cause the system selection options 344 to be updated as well. The user may be given the opportunity to update his/her preferences 342 based on the updated system selection options 344. Based on the updated user preferences 342, the PRL 346 may be updated as well.

After a mobile device 304 has attached to a particular network via an NAP and is receiving service(s) from an NSP, the mobile device 304 may receive advertisements for additional services offered by the same NSP or one or more additional NSPs. Information about such services may then be presented to the user, and the user may be given the option to purchase these services.

For example, when a mobile device 304 attaches to a particular network, the mobile device 304 may be only using the network as a broadband IP service. The network may then advertise that other services are available to be provided. Such advertisements may be provided via the NSP that the mobile device 304 is currently using.

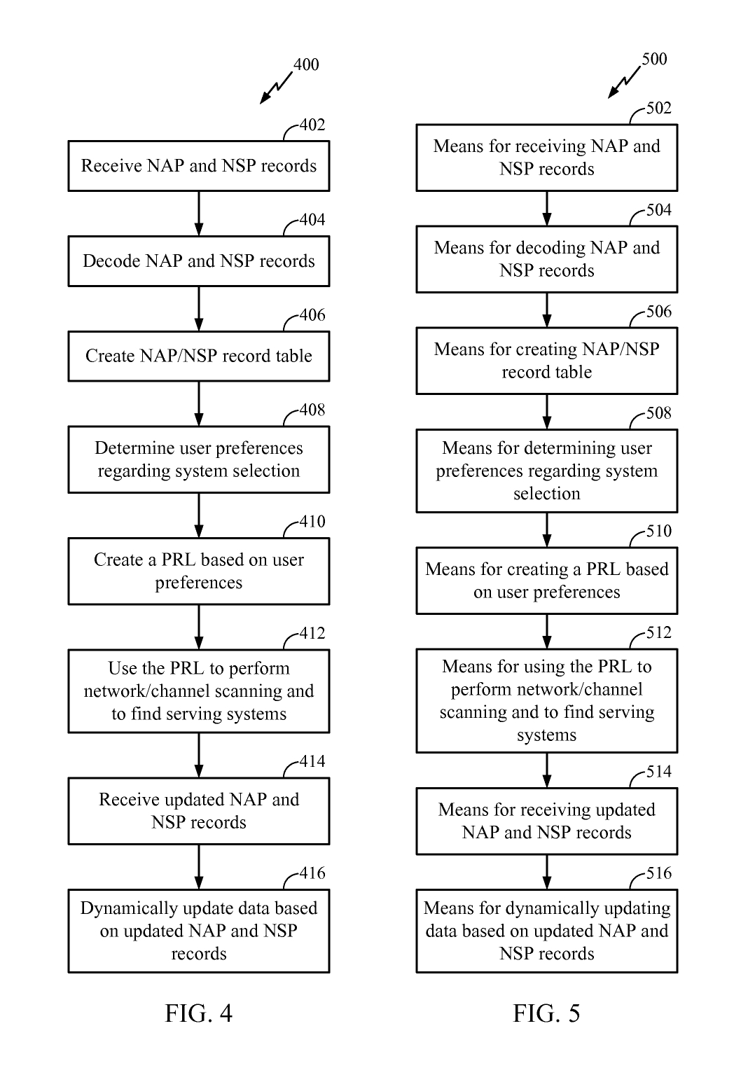

Reference is now made to FIG. 4. FIG. 4 illustrates an example of a method 400 for facilitating dynamic service-based system selection and determination. The method 400 may be implemented by a mobile device 304. The method 400 shown in FIG. 4 summarizes the functions of the mobile device 304 that were described above in connection with FIG. 3.

The mobile device 304 may receive 402 NAP records 336 and NSP records 334 from one or more network entities 332. The mobile device 304 may decode 404 the NAP records 336 and the NSP records 334 that it receives, and create 406 an NAP/NSP record table 340 based on the decoded NAP records 336 and NSP records 334.

The NAP/NSP record table 340 may be used to determine 408 user preferences 342 regarding system selection. A preferred roaming list (PRL) 346 may be created 410 based on user preferences 342. The PRL 346 may be used to perform 412 network/channel scanning and to find serving systems. However, it is not necessary that the PRL 346 is created. The NAP/NSP record table 340 may be used directly for system selection.

From time to time, the NAP records 336 and the NSP records 334 may be updated. When this occurs, the mobile device 304 may receive 414 the updated NAP records 336 and the updated NSP records 334, and dynamically update 416 data on the mobile device 304 (e.g., the NAP/NSP record table 340, the system selection options 344, the user preferences 342, the PRL 346) based on the updated NAP records 336 and the updated NSP records 334.

The method 400 of FIG. 4 described above may be performed by various hardware and/or software component(s) and/or module(s) corresponding to the means-plus-function blocks 500 illustrated in FIG. 5. In other words, blocks 402 through 416 illustrated in FIG. 4 correspond to means-plus-function blocks 502 through 516 illustrated in FIG. 5.

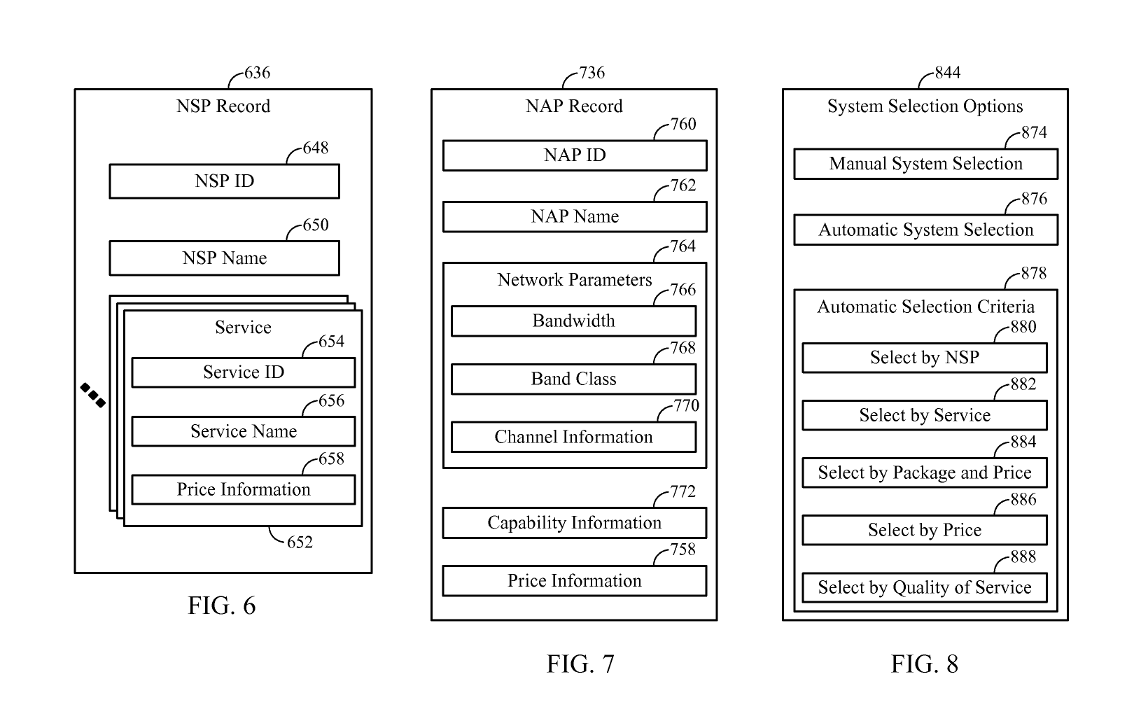

Reference is now made to FIG. 6. FIG. 6 illustrates an example of an NSP record 636. As indicated above, an NSP record 636 may include information about a particular NSP. More specifically, an NSP record 636 may include an identifier (ID) 648 for the NSP, as well as the name 650 of the NSP. In addition, an NSP record 636 may include information about one or more services 652 that are offered by the NSP. The information that is included about a particular service 652 may include an identifier (ID) 654 for the service, the name 656 of the service, price information 658 about the service, and so forth.

Instead of separately identifying each individual service 652, an NSP record 636 may include a reference to a package of multiple services 652. For example, one type of service package may include all available services 652 (e.g., IPTV, 3D gaming, World Wide Web access, email, instant messaging, VoIP, etc.), whereas another type of service package may include a subset of available services 652 (e.g., World Wide Web access, email, instant messaging, and VoIP, but not IPTV or 3D gaming).

Reference is now made to FIG. 7. FIG. 7 illustrates an example of an NAP record 736. As indicated above, an NAP record 736 may include information about a particular NAP. More specifically, an NAP record 736 may include an identifier (ID) 760 for the NAP, as well as the name 762 of the NAP. In addition, an NAP record 736 may include information about one or more network parameters 764 for the NAP, such as bandwidth 766, band class 768, channel information 770, and so forth. The network parameters 764 in the NAP record 736 may be used to create the preferred roaming list. An NAP record 736 may also include capability information 772 (e.g., maximum bit rate) and price information 758 concerning the NAP.

### System for Matching Network Service Providers with Network Access Providers

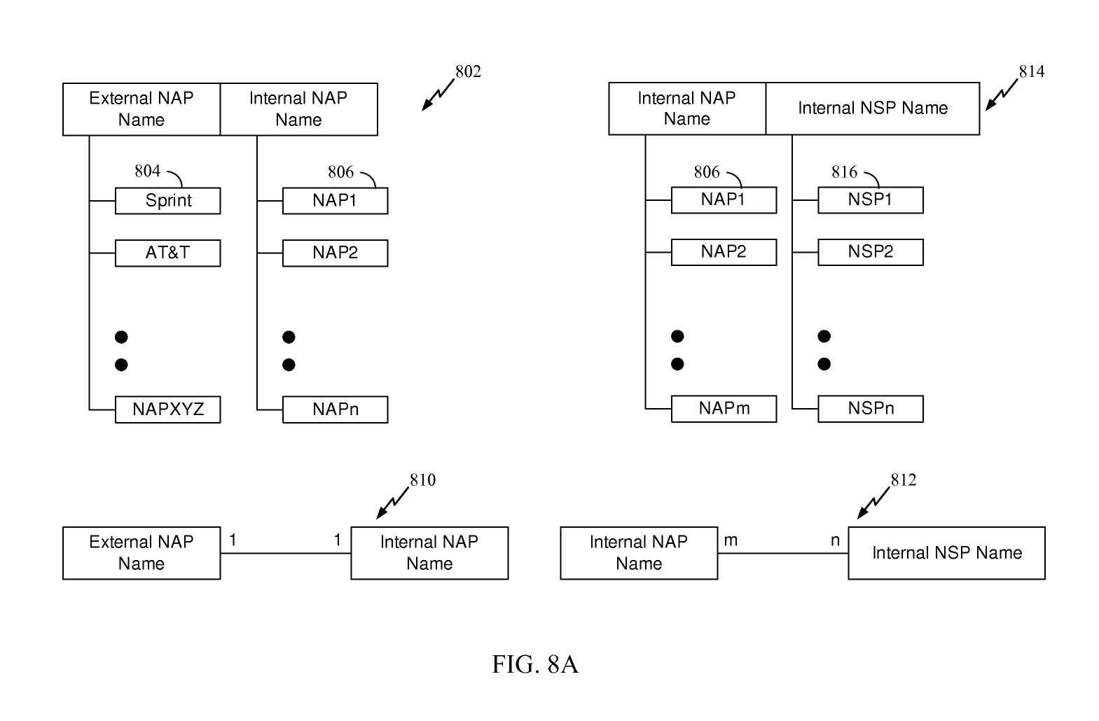

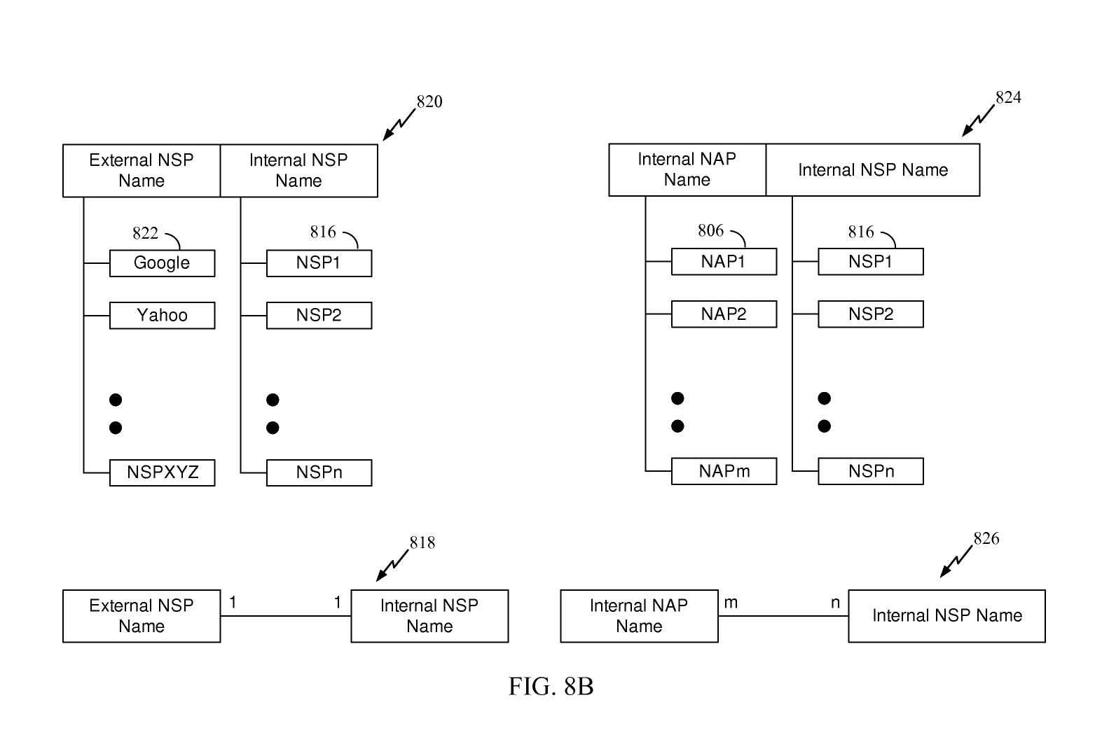

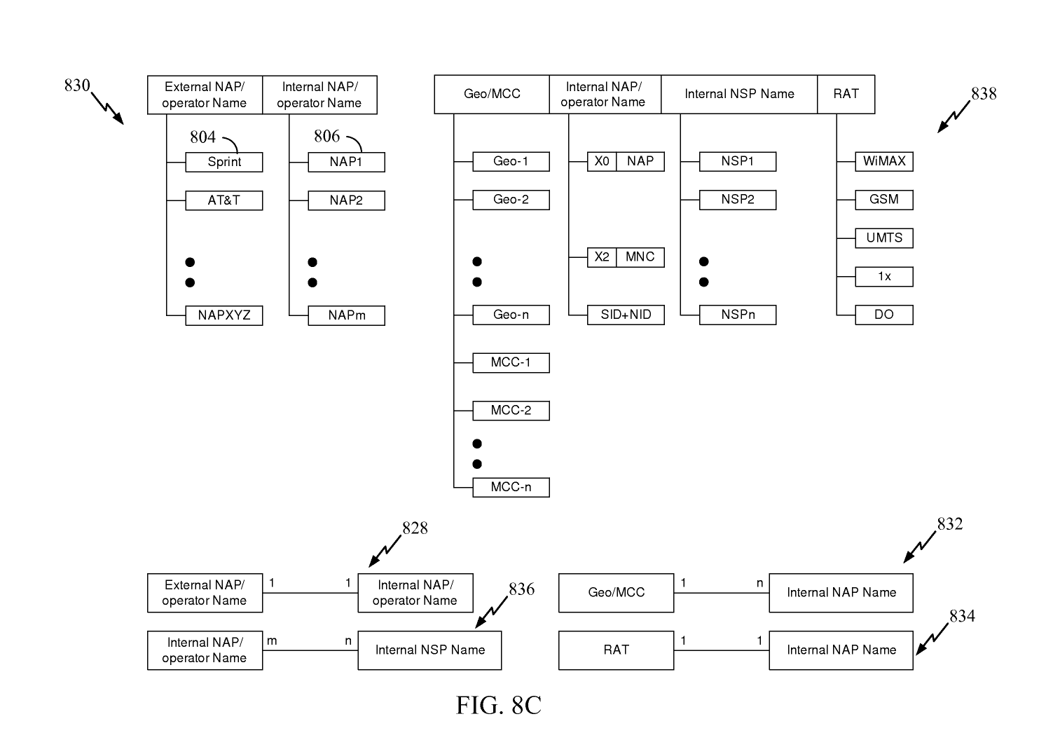

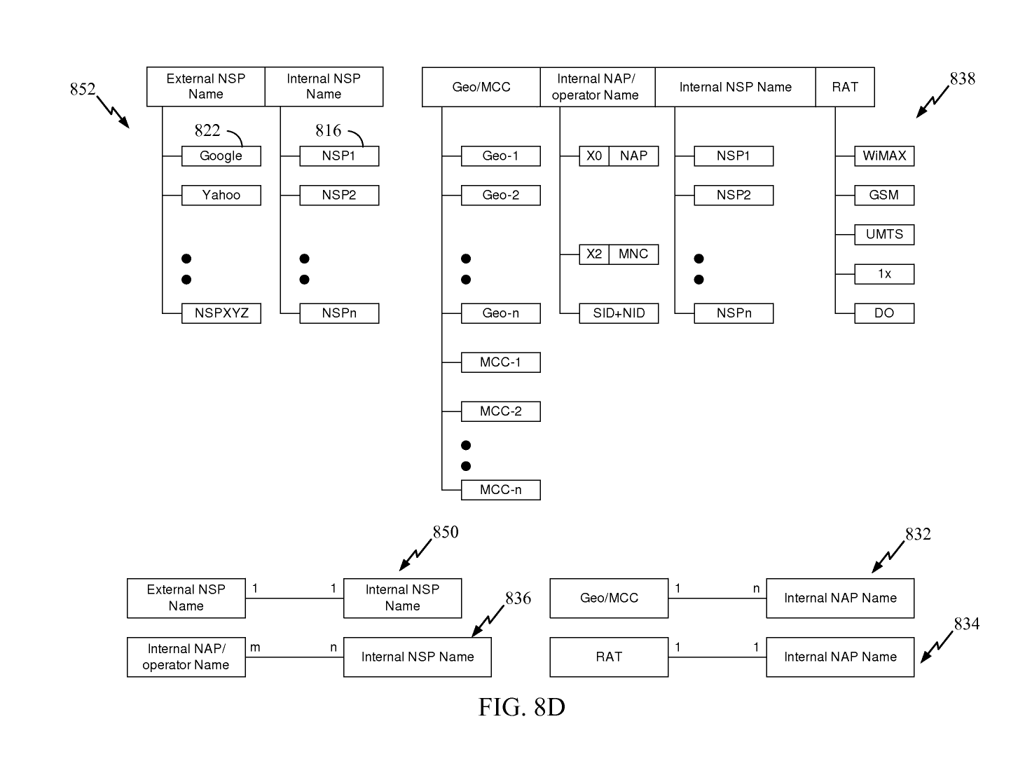

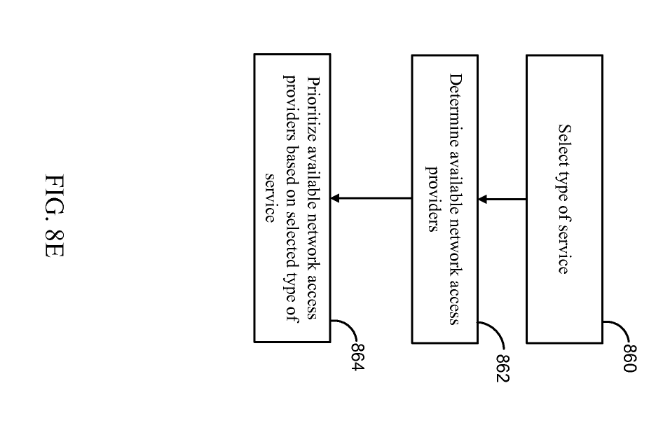

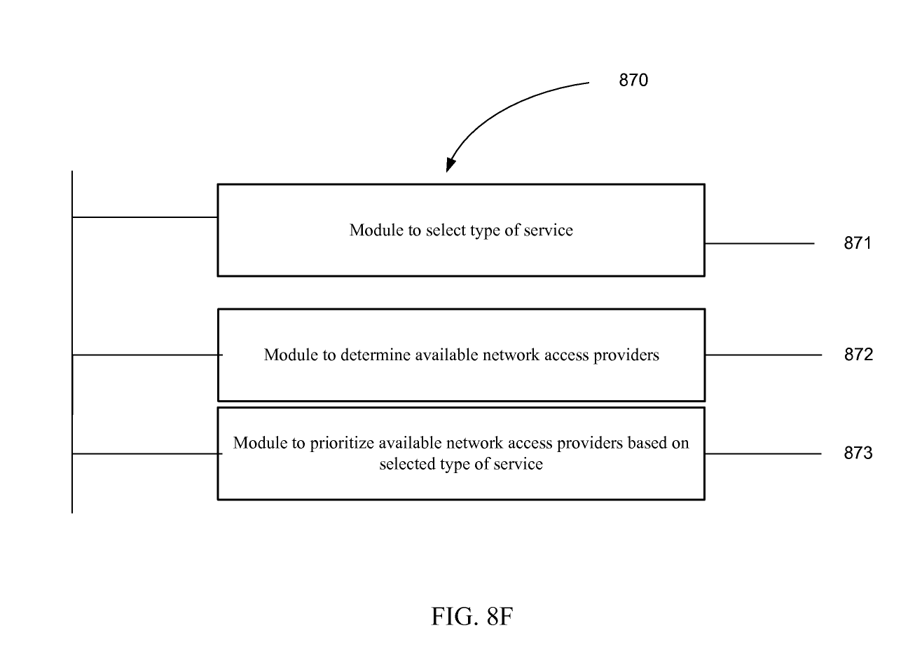

Reference is now made to FIG. 8. FIG. 8 illustrates some examples of system selection options 844. The depicted system selection options 844 include an option 874 for manual system selection, and an option 876 for automatic system selection. If the user chooses the option 874 for manual system selection, then the user may manually select the NAP and NSP(s) that are utilized. However, if the user chooses the option 876 for automatic system selection, then the mobile device may automatically select the NAP and NSP(s) that are utilized, possibly based on certain automatic selection criteria 878 that the user provides.

Some examples of automatic selection criteria 878 are shown in FIG. 8, including an option 880 to select by NSP, an option 882 to select by service, an option 884 to select by package and price, an option 886 to select by price, an option 888 to select by quality of service, etc.

For example, if the specified criterion 878 is the option 880 to “select by NSP,” then the user may be prompted to specify one or more preferred NSPs. If multiple NSPs are specified, then the user may be prompted to rank the NSPs. The mobile device may then automatically select the NAP that offers the specified NSP(s). If multiple NAPs offer the specified NSP(s), then other criteria may be used to determine which NAP is selected.

As another example, if the specified criterion 878 is the option 884 to “select by price” with respect to a particular service, then the mobile device may determine the NSP that provides the desired service at the cheapest price. The mobile device may then automatically select this NSP and the corresponding NAP that provides access to this NSP.

More generally, a user desiring to access a particular service or NSP may be connected to an NAP to access that particular service based on a variety of factors that may be configurable. Such factors include the quality of service of the NAP for a particular NSP (which may include speed of access, interference to the NAP, etc.), cost of accessing the NSP over the particular NAP, user rewards with a particular NAP or NSP, special features offered for a particular NSP over a specific NAP, etc.

For example, if a user device is capable of accessing multiple network access providers (NAPs) and a user wishes to access a particular NSP (for example YouTube), the device may weight the performance, cost, etc. of operating YouTube over each accessible NAP. The device will then access the NSP (e.g., YouTube) over an NAP based on that weighing. User preferences/settings, network settings, device settings, and various other settings may be considered when performing the weighing. When the device determines a desired NAP (for example a local free WiFi network), the device will use the NAP to access the NSP, in this example, YouTube.

When matching a desired NAP for a specific NSP the device may employ hardware, software, or some combination thereof to weight the factors mentioned above. A device may input information relevant to NAP-to-NSP matching from a number of sources. Such sources include user input and preferences (which may be input directly into the device or imported to the device from an external source), network information (which may include information regarding potential commercial relationships between services and networks that may impact a cost analysis when matching NAPs to NSPs), communication conditions (such as the performance of accessing specific NSPs over available NAPs), etc.

The device may maintain one or more tables indicating which NAPs should be used to access which NSPs. The table may be accessed upon request for activation of a particular NSP. The device may update the table upon the request for the NSP and/or may update the table in the background as information settings change to enable faster launching of a desired NSP when a request is made.

Although the described NSP-to-NAP matching may be performed in a variety of networks, operation is illustrated below with reference to a WiMAX network. Specifically, an NSP-based system selection method for WiMAX-based single mode and multi-mode systems is described. The proposed scheme allows the connectivity information of the service provider with the operator provider to be changed either automatically or as indicated by a user.

A system identity information advertisement (SII-ADV) message may contain the Network Service Provider (NSP) List of a base station. The NSP list is also associated with a change count that is broadcast in the downlink channel descriptor (DCD) message. A change in the NSP List change count implies the NSP List has changed. When an NSP list has changed, a mobile device may re-evaluate whether the current base station is still suitable. The interval between two consecutive SII-ADVs can be up to 30 seconds. The default period of the broadcast is 10 seconds. If a change in the change count happens when the mobile device is unavailable, the mobile device will not have an up-to-date NSP List. The impact of this, however, is not critical. There is currently no provisioning for the SII-ADV broadcast in a broadcast control pointer information element (BCP IE).

The following procedures may be employed to maintain a current NAP-to-NSP matching list. A set of tables may be used by a mobile device to store related information for system/network selection. One or more NAP-NSP tables may be used to map connections between an NAP and an NSP. An NAP-frequency acquisition table may guide the mobile device to search for signals broadcast by a set of base stations owned by a given operator (NAP) through a given frequency or a set of frequencies. An NSP table with priority may be provided to the mobile users during the provisioning period.

During a first time power-up, or when travelling to a new area, the mobile station starts from a highest priority NSP. As multiple NAPs may map to a single NSP, the mobile device may iterate these multiple NAPs until the mobile device finds a suitable cell to camp on. When an NAP is found, if SII-ADV is not available, then the mobile device derives the corresponding frequency from the acquisition table and starts the measurement and initial network entry procedure. Otherwise, the mobile device checks whether a given NSP is inside an NAP's SII-ADV message. If a given frequency does not assist a mobile device to locate a suitable cell, the mobile device tries other frequency belonging to the same NAP from the acquisition table to repeat the same procedure.

If the mobile device still cannot find a suitable cell from a given NAP, the mobile device will store the SII-ADV message and try the next NAP using the same NSP from the NSP-NAP matched result and repeat the same procedure. If the mobile device still is unable to find a suitable cell from a given NSP, the mobile device will try the next NSP from the NSP priority table. If no NSPs are found in the current region, the mobile device may use the available network provided by any NAP to access to the network. If none of the NAPs are available in the current region, the mobile device may switch to another radio access technology (for example, from WiMAX to Long Term Evolution (LTE) or to WLAN, etc. Using the above procedure, the mobile station will connect to the network to access the desired NSP.

When a mobile device revisits an area it has previously visited, it may implement the following procedure. The mobile device may access a memory storing the working/registered NSP-NAP mapping with the working frequency derived from NAP's SII-ADV messages. The mobile device may use the stored NSP-NAP mapping to derive the NSP, NAP, and frequency. The mobile device will use the derived frequency to camp on a network. If the mobile device is unable to camp on a network using any frequency under a given NAP, the mobile device will use the NSP-NAP mapping to derive other NAPs mapped with the same NSP, and use the NAP to derive a frequency to restart the above procedure. If a mobile device is unable to camp on to a network using any frequency under a given NSP, the mobile device may try the next NSP from the NSP priority table. If none of the NSPs in the priority table are found in the current region, the mobile station may use the available network provided by any NAP to access to the network. If none of the NAPs are available in the current region, the mobile station may switch to a different radio access technology (RAT) (for example, WiMAX, LTE, Bluetooth, WLAN, etc.). The above procedure may be used by the mobile station to connect with a network.

A SII-ADV message may contain a list of NSPs supported by a given NAP. When NAP-NSP mapping is updated, new NAP-NSP mapping may be broadcast by a NAP in a SII-ADV message. New mapping according to such messages may be identified by a mobile device. When listening to a given NAP's cell overhead information, if a mobile device determines that there is a change in the NSP list such as an added or deleted NSP element belonging to the preferred NSP list, the mobile station may make a corresponding change on its NAP-NSP mapping table. If a new NSP is added to a given NAP's SII-ADV but not included in the current NSP-NAP table, and there is no other NSP belonging to this NAP stored in the NSP-NAP table, the mobile device may not immediately automatically identify this change unless the mobile device starts the spectrum scan to visit all of the available operator frequencies. In order to prevent this problem, the service provider may use the internet protocol (IP) or other high level protocol to inform the mobile device of a new operator being added to the NSP-NAP list.

The Network Service Provider oriented feature of a multi-mode system selection may be extended. The network service provider feature may be introduced into current 3GPP and 3GPP2 standard based operating networks. Presently, 3GPP and 3GPP2 networks do not broadcast the SII-ADV message to mobile devices. Thus, if there is any change in NAP-NSP mapping, a mobile device may not be informed through the L2 level communication protocol. To resolve this, the network may be reconfigured to provide an NAP-NSP query server to allow a mobile device to query potential NAP-NSP mapping changes in an on-demand fashion. The NAP-NSP query server may post a future NAP-NSP change schedule to inform mobile devices to query the server at particular times to identify potential change notices.

Using the proposed method, a mobile device may automatically search for network access providers that have particular relationships (such as a special contract) with the network service providers. Those special relationships, along with other factors such as communication conditions influence the selection.

The mobile station may be informed of account changes in such relationships, and the mobile station will update the NAP-NSP mapping through the periodic SII-ADV broadcasting messages. The proposed scheme further extends the domain from WiMAX to 3GPP and 3GPP2 to support the unified system selection interface. Below are certain examples illustrating the NAP or NSP selection depending on mobile device communication capability.

A mobile device capable of single network communication (for example capable of communicating using a single RAT only, such as WiMAX) may selected a network access provider (NAP) as follows. During the system selection process, a mapping process is used to map the external NAP name (as might be known to the user) and the internal NAP name (as might be used by the mobile device) as shown in the mapping 810 in FIG. 8A. The mapping results are stored in a mapping table. FIG. 8A shows such a table 802 storing a list of NAPs with their external names 804 and their internal names 806. The NAPs shown in table 802 are potential networks of the type operable by the mobile device (for example, WiMAX). The mobile user may choose the external NAP. Alternatively, the system determination module may use a preference to determine an initial NAP. From the SII-ADV broadcasting messages, a mobile device may determine which network service providers (NSPs) are available in a particular region. The system may match a list of network service providers (NSPs) with a preferred NAP as shown in the mapping 812. Those matches may then be stored in a table 814. The table 814 matches NAPs with NSPs by matching internal NAP names 806 with internal NSP names 816. An NAP may be selected based on a desired NSP that a user wishes to access. The system may choose an NAP to access the NSP that will provided a desired system performance to the user (i.e., a network that will access the service at a low cost, with good performance, etc.)

A mobile device capable of single network communication (for example capable of communicating using a single RAT only, such as WiMAX) may select a network service provider (NSP) as follows. During the system selection process, a mapping process maps the external NSP name (as might be known to the user) and the internal NSP name (as might be used by the mobile device) as shown in the mapping 818 in FIG. 8B. The mapping results are stored in a mapping table. FIG. 8B shows such a table 820 storing a list of NSPs with their external names 822 and their internal names 816. The mobile user may choose the external NSP. Alternatively, the system determination module may use a preference to determine an initial NSP. From the SII-ADV broadcasting messages, a mobile device may determine whether a chosen NSP is available in a particular region. The system may match a list of network access providers (NAPs) with a preferred NSP as shown in the mapping 826. Those matches may then be store in a table 824. The table 814 matches NSPs with NAPs by matching internal NAP names 806 with internal NSP names 816.

A mobile device capable of multi-mode network communication (for example, capable of communicating using multiple RATs, such as WiMAX and LTE) may select a network access provider (NAP) as follows. During the system selection process, a mapping process maps the external NAP name (as might be known to the user) and the internal NAP name (as might be used by the mobile device) as shown in the mapping 828 in FIG. 8C. The mapping results are stored in a mapping table. FIG. 8C shows such a table 830 storing a list of NAPs with their external names 804 and their internal names 806. The mobile user may start from the geographical information selection if a mobile device travels to a different location or different country. This may narrow the NAP search list. NAPs may be mapped to a geographic code (Geo) or mobile country code (MCC) as shown in the mapping 832.

Once an external NAP is chosen, the system will decide which RAT is used. Some network operators such as AT&T, Sprint, etc. may operate multiple RAT networks in the same area. RAT preferences may be configured during a RAT preference configuration operation. NAPs may be mapped with a RAT as shown in the mapping 834. From the SII-ADV broadcasting messages, a mobile device can see which NSPs are available in a particular region. Depending on the RAT (for example, WiMAX) NAPs may be matched with NSPs as shown in the mapping 836. A table 838 may be created linking geographic information (such as geographic codes and mobile country codes), internal NAP name (which may be chosen by a mobile device or may be an identifier such as a mobile network codes (MNC), system identification code (SID), or network identification code (NID)), desired NSP by internal names, and available RAT technologies (such as WiMAX, GSM, UMTS, etc.).

The system may choose an NAP/RAT to access the NSP that will provided a desired system performance to the user (i.e., a network that will access the service at a low cost, with good performance, etc.) The system may choose an NAP to access the NSP that will provided a desired system performance to the user (i.e. a network that will access the service at a low cost, with good performance, etc.).

A mobile device capable of multi-mode network communication (for example, capable of communicating using multiple RATs, such as WiMAX and LTE) may select a network service provider (NSP) as follows. During the system selection process, a mapping process maps the external NSP name (as might be known to the user) and the internal NSP name (as might be used by the mobile device) as shown in the mapping 850 in FIG. 8D. The mapping results are stored in a mapping table. FIG. 8D shows such a table 852 storing a list of NSPs with their external names 822 and their internal names 816. The mobile user may start from the geographical information selection if a mobile device travels to a different location or different country. This may narrow the NSP search list.

NAPs may be mapped to a geographic code (Geo) or mobile country code (MCC) as shown in the mapping 832. NAPs may be mapped with a RAT as shown in the mapping 834. Once the external NSP is chosen, the system may derive a list of NAPs matched with NSPs. A table 838 may be created linking geographic information (such as geographic codes and mobile country codes), internal NAP name (which may be chosen by a mobile device or may be an identifier such as a mobile network codes (MNC), system identification code (SID), or network identification code (NID)), desired NSP by internal names, and available RAT technologies (such as WiMAX, GSM, UMTS, etc.) For certain RATs, from the SII-ADV broadcasting messages, a mobile device may determine whether a chosen NSP is available in a particular region.

The above choice procedures may be used to match NAPs with NSPs to provide users with a match of NAP to NSP to provide a user with a service at a desired performance level.

FIG. 8E illustrates a method of matching an NAP to an NSP according to one aspect of the present disclosure. A mobile device or other apparatus selects a type of service, as shown in block 860. The device determines available network access providers, comprising cellular and non-cellular networks, as shown in block 862. The device prioritizes available network access providers based at least in part on the selected type of service, as shown in block 864.

FIG. 8F shows a design of an apparatus 870 for a user terminal, such as the user terminal 104 of FIG. 8F. The apparatus 870 includes a module 871 for selecting a type of service. The apparatus 870 also includes a module 872 for determining available network access providers, comprising cellular and non-cellular networks. The apparatus also includes a module for prioritizing available network access providers based at least in part on the selected type of service. The modules in FIG. 8F may be processors, electronics devices, hardware devices, electronics components, logical circuits, memories, software codes, firmware codes, etc., or any combination thereof.

In one configuration, the mobile device 104 is configured for wireless communication including means for selecting a type of service, means for determining available network access providers, and means for prioritizing available network access providers. In one aspect, the above means may be the memory 228b, the controller/processor 214b, the receiver 222b, instructions 1291, module 871, module 872, and/or module 873. In another aspect, the aforementioned means may be a module or any apparatus configured to perform the functions recited by the aforementioned means.

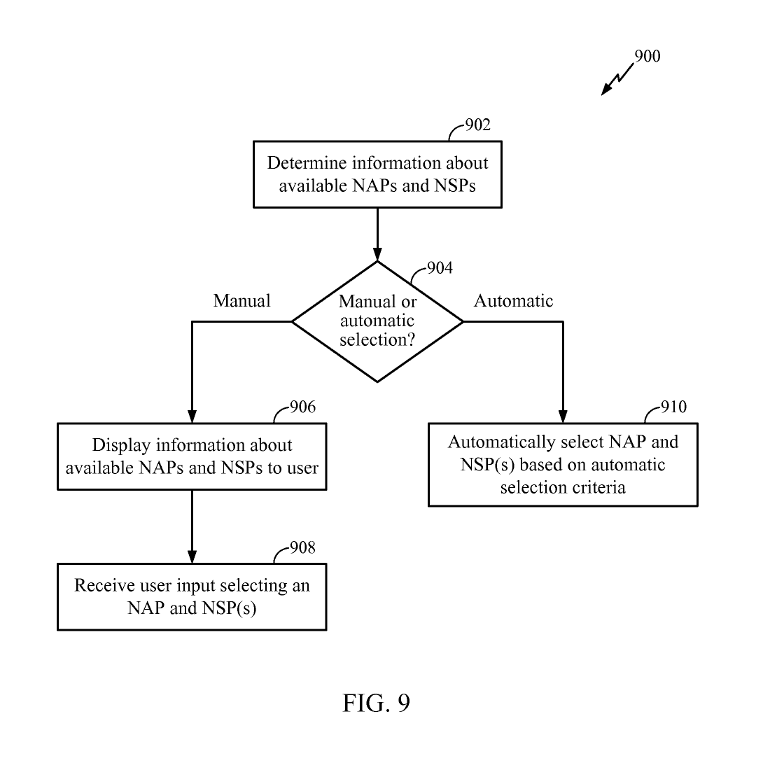

Reference is now made to FIG. 9. FIG. 9 illustrates an example of a method 900 for locating a serving system in accordance with the present disclosure. The method 900 may be implemented by a mobile device after power up, when the device needs a system re-selection after losing the current serving system, etc.

The mobile device may determine 902 information about available NAPs and NSPs. This is not merely limited to the NAPs and NSPs that are already provisioned on the mobile device; rather, information about other NAPs and NSPs that are not provisioned on the mobile device may also be determined This may involve referring to an NAP/NSP record table that has been created based on NAP records and NSP records that have been received. Alternatively, or in addition, this may involve actively searching for information about available NAPs and NSPs.

The mobile device may determine 904 whether the user has indicated a preference for manual or automatic selection. If manual selection has been chosen, then the mobile device may display 906 information about available NAPs and NSPs to the user, and receive 908 user input selecting an NAP and NSPs. However, if automatic selection has been chosen, then the mobile device may automatically select 910 an NAP and NSPs based on automatic selection criteria that have been specified by the user.

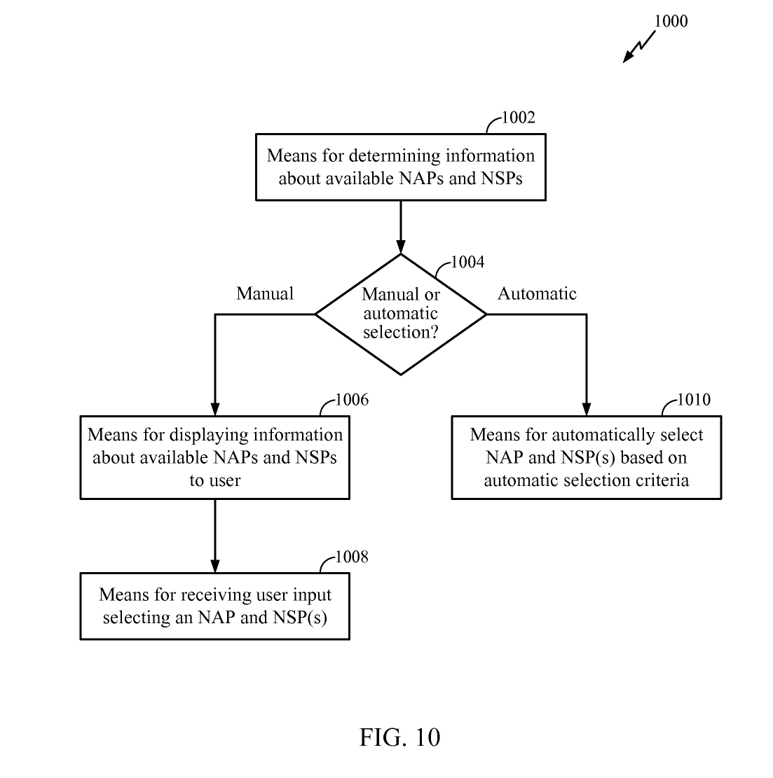

The method 900 of FIG. 9 described above may be performed by various hardware and/or software component(s) and/or module(s) corresponding to the means-plus-function blocks 1000 illustrated in FIG. 10. In other words, blocks 902 through 910 illustrated in FIG. 9 correspond to means-plus-function blocks 1002 through 1010 illustrated in FIG. 10.

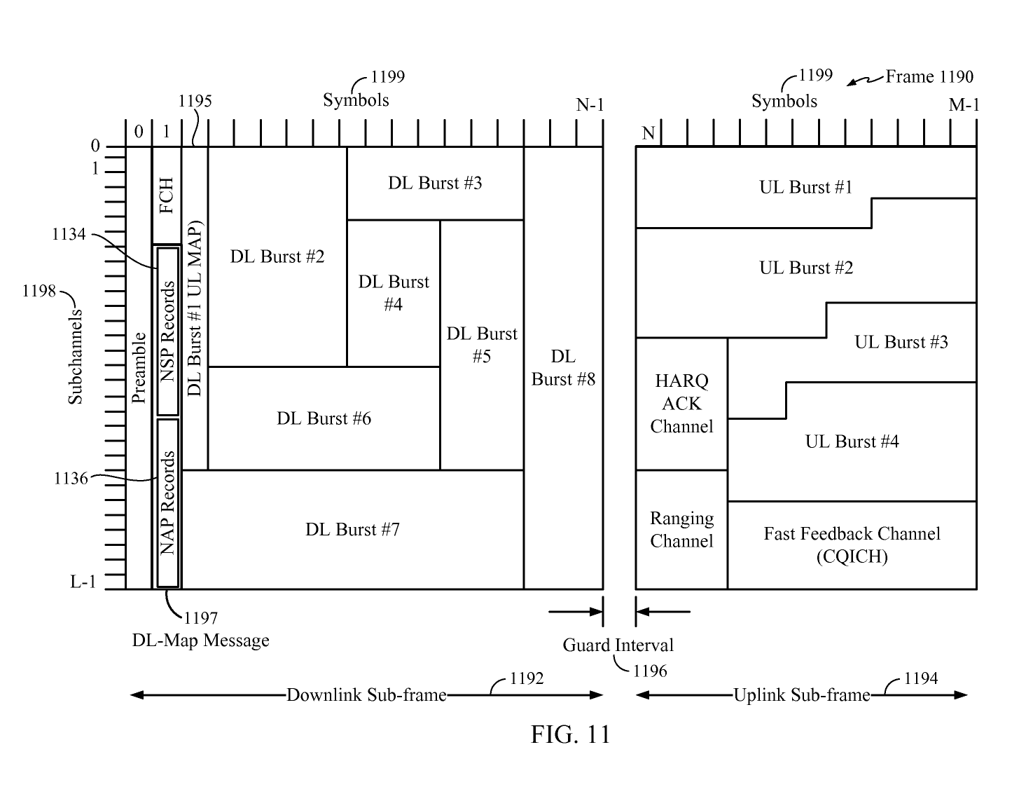

The techniques disclosed herein may be utilized in a WiMAX network. Reference is now made to FIG. 11. FIG. 11 illustrates an example showing certain aspects of the structure of a frame 1190 in a WiMAX network. The frame 1190 includes a downlink sub-frame 1192 and an uplink sub-frame 1194, separated by a guard interval 1196. The frame 1192 is transmitted over L subchannels 1198. There are a total of M symbols 1199 in the frame, N symbols 1199 in the downlink sub-frame 1192 and M-N symbols 1199 in the uplink sub-frame 1194.

Multiple users are allocated data regions within the frame 1192, and these allocations are specified in the downlink MAP (DL-MAP) message 1197 and the uplink MAP (UL-MAP) message 1195. The MAP messages 1197, 1195 include the burst profile for each user, which defines the modulation and coding schemes that are used.

In accordance with the present disclosure, NAP records 1136 and NSP records 1134 may be included within the DL-MAP message 1197. Thus, by decoding the DL-MAP message 1197, the mobile device may be able to determine information about available NAPs and NSPs, and then create an NAP/NSP record table based on this information.

The NAP ID may be broadcasted as the Base Station ID. The NSP ID may be unicasted through the Subscriber Station Basic Capability Response (SBC-RSP) message and the Service Identity Information (SII-ADV) message. Those messages may be extended to include the information disclosed herein.

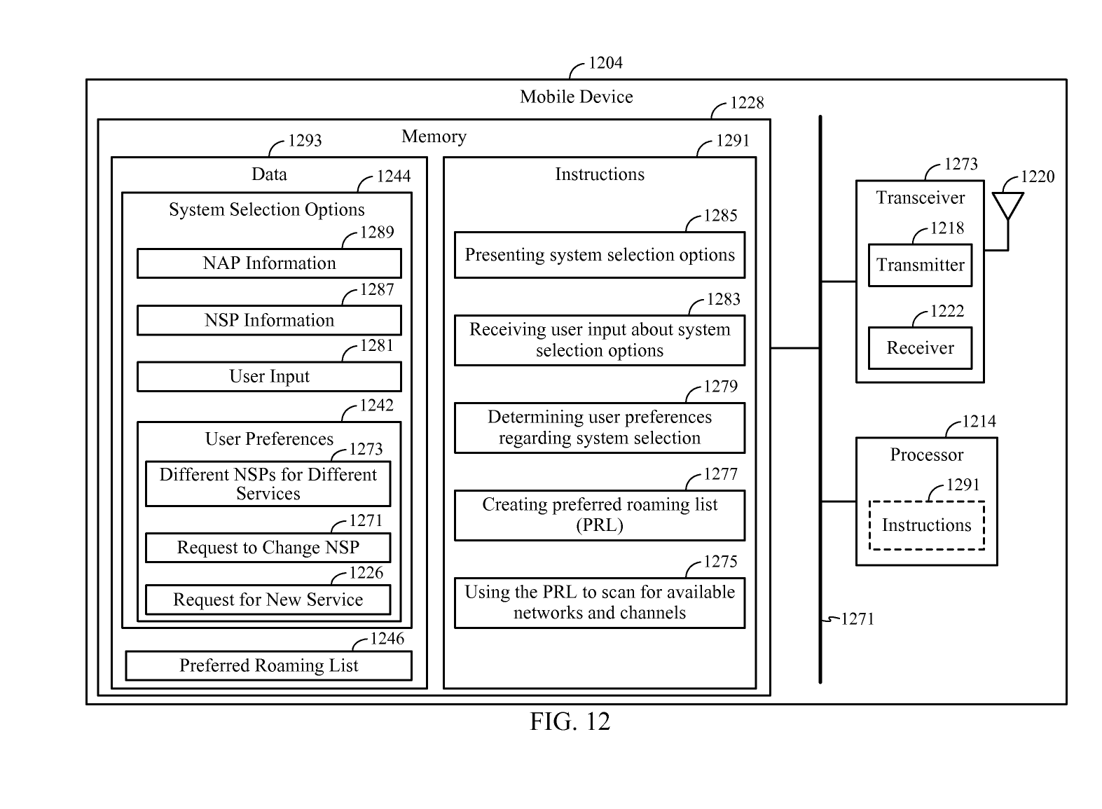

Reference is now made to FIG. 12. FIG. 12 illustrates certain components that may be included within a mobile device 1204 that is configured for facilitating dynamic service-based system selection and determination in accordance with the present disclosure.

The mobile device 1204 includes a processor 1214. The processor 1214 may be a general purpose single- or multi-chip microprocessor (e.g., an ARM), a special purpose microprocessor (e.g., a digital signal processor (DSP)), a microcontroller, a programmable gate array, etc. The processor may be referred to as a central processing unit (CPU). Although just a single processor is shown in the mobile device 1204 of FIG. 12, in an alternative configuration, a combination of processors 1214 (e.g., an ARM and DSP) could be used.

The mobile device 1204 also includes memory 1228. The memory 1228 may be any electronic component capable of storing electronic information. The memory 1228 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 1293 and instructions 1291 may be stored in the memory 1228. The instructions 1291 may be executable by the processor 1214 to implement various functions. Executing the instructions 1291 may involve the use of the data 1293 that is stored in the memory 1228.

The mobile device 1204 may include instructions 1285 for presenting system selection options 1244 to a user based on information 1289, 1287 that is received about Network Access Providers (NAPs) and Network Service Providers (NSPs). The NAP information 1289 may take the form of the NAP records discussed previously. Similarly, the NSP information 1287 may take the form of the NSP records discussed previously.

The mobile device 1204 may also include instructions 1283 for receiving user input 1281 about the system selection options 1244. The user may be permitted to provide input about specific services offered by specific NSPs.

The mobile device 1204 may also include instructions 1279 for determining user preferences 1242 regarding system selection based on the user input 1281. Many different kinds of user preferences 1242 may be determined. For example, the user preferences 1242 may include a user selection 1273 of different NSPs for different services (as described in Example 1 above). As another example, the user preferences 1242 may include a request 1271 to change the NSP that is utilized for a particular service (as described in Example 2 above). As yet another example, the user preferences 1242 may include a request 1269 to sign up for a new service (as described in Example 3 above).

The mobile device 1204 may also include instructions 1277 for creating a preferred roaming list (PRL) 1246 based on the user preferences 1242. Further, the mobile device 1204 may also include instructions 1275 for using the PRL 1246 to scan for available networks and channels and to find serving systems.

Other types of instructions 1291 and data 1293 that are relevant to implementing the techniques described herein may also be included in the memory 1228.

The mobile device 1204 may also include a transmitter 1218 and a receiver 1222 to allow transmission and reception of signals between the mobile device and a remote location. The transmitter 1218 and receiver 1222 may be collectively referred to as a transceiver 1277. An antenna 1220 may be electrically coupled to the transceiver 1277. The mobile device 1204 may also include (not shown) multiple transmitters, multiple receivers, multiple transceivers and/or multiple antenna.

The various components of the mobile device 1204 may be coupled together by one or more buses, which may include a power bus, a control signal bus, a status signal bus, a data bus, etc. For the sake of clarity, the various buses are illustrated in FIG. 12 as a bus system 1275.

The techniques disclosed herein may provide a number of advantages relative to known approaches. For example, the techniques disclosed herein may allow a user to select the services that she/he wants in addition to operators and service providers.

Additionally, information about network operators, service providers, and their service and price information can be added, deleted, and changed. The new information can be communicated to the mobile devices via a local connection and/or via an over-the-air connection. Mobile devices can dynamically update the operator, service provider and service information and present the updated information to the users. This allows new operators, service providers, and services to be introduced to the users easily. This is especially useful with the rollout of 4G systems.

Another potential advantage of the techniques disclosed herein is that the mobile devices can dynamically update the preferred roaming list to enable efficient channel scanning This may help to reduce the power consumption of the mobile device and facilitate faster serving system selection.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure. For example, a reference to “mobile device 1204” refers to the specific mobile device that is shown in FIG. 12. However, the use of “mobile device” without a reference number refers to any mobile device that is appropriate for the context in which the term is used, and is not limited to any particular mobile device shown in the Figures.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements. The terms “instructions” and “code” may be used interchangeably herein.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4 and 9, can be downloaded and/or otherwise obtained by a mobile device as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method of wireless communication, comprising:
selecting a type of service;
determining available network access providers, comprising cellular and non-cellular networks; and
prioritizing available network access providers based at least in part on the selected type of service.

2. The method of claim 1 in which the prioritizing is based at least in part on at least one criteria including power consumption, communication performance, reward availability, and cost associated with each available network access provider for the selected type of service.

3. The method of claim 2 in which the at least one criteria further includes a prior use history of each available network access provider for the selected type of service.

4. The method of claim 1, further comprising selecting a highest priority network for wirelessly accessing the selected type of service.

5. The method of claim 1 in which the selecting further comprises determining a location and network access providers available at the location.

6. An apparatus for wireless communication comprising:
means for selecting a type of service;
means for determining available network access providers, comprising cellular and non-cellular networks; and
means for prioritizing available network access providers based at least in part on the selected type of service.

7. The apparatus of claim 6 in which the means for prioritizing is based at least in part on at least one criteria including power consumption, communication performance, reward availability, and cost associated with each available network access provider for the selected type of service.

8. The apparatus of claim 7 in which the at least one criteria further includes a prior use history of each available network access provider for the selected type of service.

9. The apparatus of claim 6, further comprising means for selecting a highest priority network for wirelessly accessing the selected type of service.

10. The apparatus of claim 6 in which the means for selecting further comprises means for determining a location and network access providers available at the location.

11. A computer program product, comprising:
a non-transitory computer-readable medium having non-transitory program code recorded thereon, the non-transitory program code comprising:
program code to select a type of service;
program code to determine available network access providers, comprising cellular and non-cellular networks; and
program code to prioritize available network access providers based at least in part on the selected type of service.

12. The computer program product of claim 11 in which the program code to prioritize is based at least in part on at least one criteria including power consumption, communication performance, reward availability, and cost associated with each available network access provider for the selected type of service.

13. The computer program product of claim 12 in which the at least one criteria further includes a prior use history of each available network access provider for the selected type of service.

14. The computer program product of claim 11, further comprising program code to select a highest priority network for wirelessly accessing the selected type of service.

15. The computer program product of claim 11 in which the program code to select further comprises program code to determine a location and network access providers available at the location.

16. An apparatus configured for wireless communication, comprising:
at least one processor; and
a memory coupled to said at least one processor, wherein said at least one processor is configured:
to select a type of service;
to determine available network access providers, comprising cellular and non-cellular networks; and
to prioritize available network access providers based at least in part on the selected type of service.

17. The apparatus of claim 16 in which the at least one processor configured to prioritize is based at least in part on at least one criteria including power consumption, communication performance, reward availability, and cost associated with each available network access provider for the selected type of service.

18. The apparatus of claim 17 in which the at least one criteria further includes a prior use history of each available network access provider for the selected type of service.

19. The apparatus of claim 16, in which the at least one processor is further configured to select a highest priority network for wirelessly accessing the selected type of service.

20. The apparatus of claim 16 in which the at least one processor is further configured to determine a location and network access providers available at the location.
